(19) United States
(12) Patent Application Publication
(10) Pub. No.: US 2021/0190594 A1
(43) Pub. Date: Jun. 24, 2021

(54) PERSONAL ELECTRONIC DEVICE WITH BUILT-IN VISIBLE CAMERA AND THERMAL SENSOR WITH THERMAL INFORMATION AVAILABLE IN THE VISIBLE CAMERA USER INTERFACE AND DISPLAY

(71) Applicant: Seek Thermal, Inc., Goleta, CA (US)

(72) Inventors: Russ Mead, Santa Barbara, CA (US); Leonard Araki, Santa Barbara, CA (US)

(21) Appl. No.: 17/125,852

(22) Filed: Dec. 17, 2020

Related U.S. Application Data
(60) Provisional application No. 62/949,690, filed on Dec. 18, 2019.
(60) Provisional application No. 62/966,776, filed on Jan. 28, 2020.

(51) Int. Cl. G01J 5/00; H04N 5/33; G01J 5/08; H04N 5/232; G06F 3/0484; G01J 5/32; G01J 5/60

(52) U.S. Cl. CPC G01J 5/0066; H04N 5/332; G01J 5/089; G01J 2005/0077; G06F 3/04847; G01J 5/32; G01J 5/60; H04N 5/232935

(57) ABSTRACT

Systems and methods that integrate thermal sensors into PED's, where those sensors may include single, or small number, of pixel temperature sensors up to full image capable built-in thermal cameras acting as an additional camera for a PED user. These sensors may be associated with dedicated thermal applications for expert users. For less expert consumers, a capability to pass thermal data through the native visible camera application (app), whose use is already familiar to the PED user, will be provided. This integration of thermal image data with the visible image and familiar visible camera app controls is intended to provide any user with useful thermal information regardless of degree of familiarity with thermal information.

### CROSS-REFERENCE TO RELATED APPLICATIONS

This application claims the benefit of U.S. Provisional Application Ser. No. 62/949,690, filed Dec. 18, 2019, and U.S. Provisional Application Ser. No. 62/966,776, filed Jan. 28, 2020, both entitled PERSONAL ELECTRONIC DEVICE WITH BUILT-IN VISIBLE CAMERA AND THERMAL SENSOR WITH THERMAL INFORMATION AVAILABLE IN THE VISIBLE CAMERA USER INTERFACE AND DISPLAY, both of which are incorporated by reference herein in their entirety.

### FIELD

The present disclosure generally relates to imaging systems including thermal imaging sensors, and in particular to the application of thermal sensors to Personal Electronic Devices (PEDs), such as smartphones, tablets and the like.

### BACKGROUND

The increasing availability of high-performance, low-cost uncooled thermal imaging devices, such as those based on bolometer focal plane arrays (FPAs), is enabling the design and production of consumer-oriented thermal imaging cameras and sensors capable of quality thermal imaging. Such thermal imaging systems have long been expensive and difficult to produce, thus limiting the employment of high-performance, long-wave imaging to high-value instruments, such as aerospace, military, or large-scale commercial applications. Thermal imaging systems of a given design produced in quantity may have different design requirements than complex military or large industrial systems. As thermal imaging cameras are adopted as built-in components for Personal Electronic Devices (PED's), such as smartphones, tablets and the like, presenting thermal data in a form accessible to consumers will be increasingly important.

### SUMMARY

The systems and methods of this disclosure each have several innovative aspects, no single one of which is solely responsible for its desirable attributes. Without limiting the scope as expressed by the claims that follow, its more prominent features will now be discussed briefly.

Systems and methods may be provided that integrate thermal sensors into PED's, where those sensors may include single, or small number, of pixel temperature sensors up to full image capable built-in thermal cameras acting as an additional camera for a PED user. These sensors may be associated with dedicated thermal applications for expert users. For less expert consumers, a capability to pass thermal data through the native visible camera application (app), whose use is already familiar to the PED user, will be provided. This integration of thermal image data with the visible image and familiar visible camera app controls is intended to provide any user with useful thermal information regardless of degree of familiarity with thermal information.

In a first aspect, a Personal Electronic Device may be provided, including: at least one native visible camera; at least one thermal sensor, wherein at least a portion of image pixel locations from the visible and thermal sensors are mapped to each other; a native application for control and display of the visible camera; wherein the native visible camera application is configured to extract information, under user control from selected thermal sensor pixels from thermal images and display the information at least one of overlaid on, blended with, or in place of corresponding pixels in the visible camera image.

In one embodiment of the first aspect, the thermal sensor data may be the temperature of one or more center pixels in the visible image. In another embodiment of the first aspect, the thermal sensor data may be the temperature of one or more user selected pixels in the visible image. In one embodiment of the first aspect, the thermal sensor may be a thermal camera and the thermal sensor data may include thermal image frames acquired from the thermal camera.

In another embodiment of the first aspect, edge data may be extracted from the visible image, and visible image derived edge data may be mapped to all corresponding pixels in the thermal image. In one embodiment of the first aspect, edge data may be extracted from the visible by means of applying a Sobel filter to a grey-scaled conversion of the visible image. In another embodiment of the first aspect, a color bar graphic may be overlaid on the PED display to show correlation between thermal data image color and temperature. In one embodiment of the first aspect, the thermal image data and the corresponding visible image data may be alpha blended under user control.

In another embodiment of the first aspect, the thermal image data and the corresponding visible image data and visible image derived edges may alpha and edge blended under user control, including by way of one slider control. In one embodiment of the first aspect, the pixel mapping between the thermal and visible images may be at least partially accomplished with user input. In another embodiment of the first aspect, a user-selected portion of pixels from the video image may be replaced with corresponding pixels from the thermal image. In one embodiment of the first aspect, the thermal image data may replace the corresponding visible image data, or vice-versa, when the thermal image pixel values meet user selectable threshold criteria, including temperature above threshold, temperature below threshold, or temperature within threshold min/max limits.

In another embodiment of the first aspect, thermography data may be derived and saved for at least a portion of pixels in each acquired thermal image. In one embodiment of the first aspect, the thermography data is displayed directly. In another embodiment of the first aspect, pixel mapping may be accomplished by deriving and aligning edge data from the two images by at least one of automated edge detection and alignment or with user input.

In one embodiment of the first aspect, pixel mapping is accomplished at manufacture. In another embodiment of the first aspect, the Field of View (FOV) of the visible and the thermal image may not be the same and only overlapping FOV portions of the images may be map able to each other. In one embodiment of the first aspect, the FOV of the visible and the thermal image may be matched and all corresponding pixels from both images may be mapped to each other by at least one of automated alignment or with user input.

In another embodiment of the first aspect, the information displayed may be related to touch temperature including a blue region for cold and a red region for hot, wherein hot and cold are based on predetermined temperature ranges. In one embodiment of the first aspect, user controls for the slider display include choice of color tables for displayed images and choice of edge color.

In a second aspect, a method of operation of a Personal Electronic Device (PED) may be provided, including at least one native visible camera; at least one thermal sensor, and an application for control and display of the visible camera, including the steps of, mapping at least a portion of image pixel locations from the visible and thermal sensor to each other; extracting information, under user control of the native visible camera application from selected pixels from thermal images; and, displaying the thermal image information at least one of over-laid on, blended with, or in place of, corresponding pixels in the visible camera image.

In one embodiment of the second aspect, the thermal sensor data may be the temperature of one or more corresponding pixels at least one of corresponding to the center of the image or user selected. In another embodiment of the second aspect, the thermal sensor may be a camera and the thermal data is image frames acquired from the thermal camera.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations are merely examples and are not intended to be limiting. Throughout the drawings, similar symbols typically identify similar components, unless context dictates otherwise.

FIGS. 1A and 1B illustrate general arrangement of an example PED with integrated thermal.

FIGS. 2A and 2B illustrate examples of a dedicated PED thermal app and a native PED visible camera app.

FIG. 3 illustrates shows schematically an arrangement where thermal data from the thermal sensor, processed from thermal app, is passed to the native camera app.

FIG. 4 illustrates an example image processing chain utilized to convert raw thermal data into a displayable form.

FIG. 5 illustrates the example image processing chain passing processed data to the native visible camera app.

FIGS. 6A and 6B illustrate example of adding small amounts of thermal data to the visible camera app and display.

FIG. 7 illustrates an example of a user friendly visible/thermal image fusion control suitable for incorporation of thermal data into a native visible camera app

FIGS. 8A-8H illustrate example display outputs from the fusion control of FIG. 7.

FIG. 9 illustrates a PED with thermal and visible sensors with an ambient light sensing capability.

### DETAILED DESCRIPTION

The following description is directed to certain implementations for the purpose of describing the innovative aspects of this disclosure. However, a person having ordinary skill in the art will readily recognize that the teachings herein can be applied in a multitude of different ways.

Generally described, embodiments of the present disclosure relate to PED's with integrated thermal sensors. Thermal sensors are reaching a cost point where they realistically can be built into PEDs, such as smartphones, tablets, laptop computers, and the like. Whether a simple limited pixel temperature sensor or a fully imaging thermal camera, thermal sensors based on low cost technology such as uncooled photo sensors, thermal sensors have the potential to add utility to already highly capable PEDs.

Thermal data, particularly thermal imaging data, generally requires a sophisticated signal processing suite along with initial calibration to provide both accurate temperature data and quality imaging. As a result, expert analysis of thermal data makes use of multiple display and data analysis tools. For thermal sensors integrated into or with PEDs, these tools are often found in dedicated thermal imaging applications. These apps provide capability beyond the expertise, or in many cases beyond the interest level, of most PED consumers.

However, almost all PED users are familiar with the native apps that are used to operate, and display images from, the existing visible cameras (e.g., cameras configured to form images using visible light) found in almost all modern PEDs.

Advantageously, the current disclosure provides for the access of limited but useful thermal data integration with the visible camera data in the native camera app. Of further advantage, the current disclosure provides some examples of specific simple user-controlled actions that can be included within a native camera application, that provide significant thermal information in an intuitive and easily accessible fashion to consumers who are non-experts in thermal imaging applications.

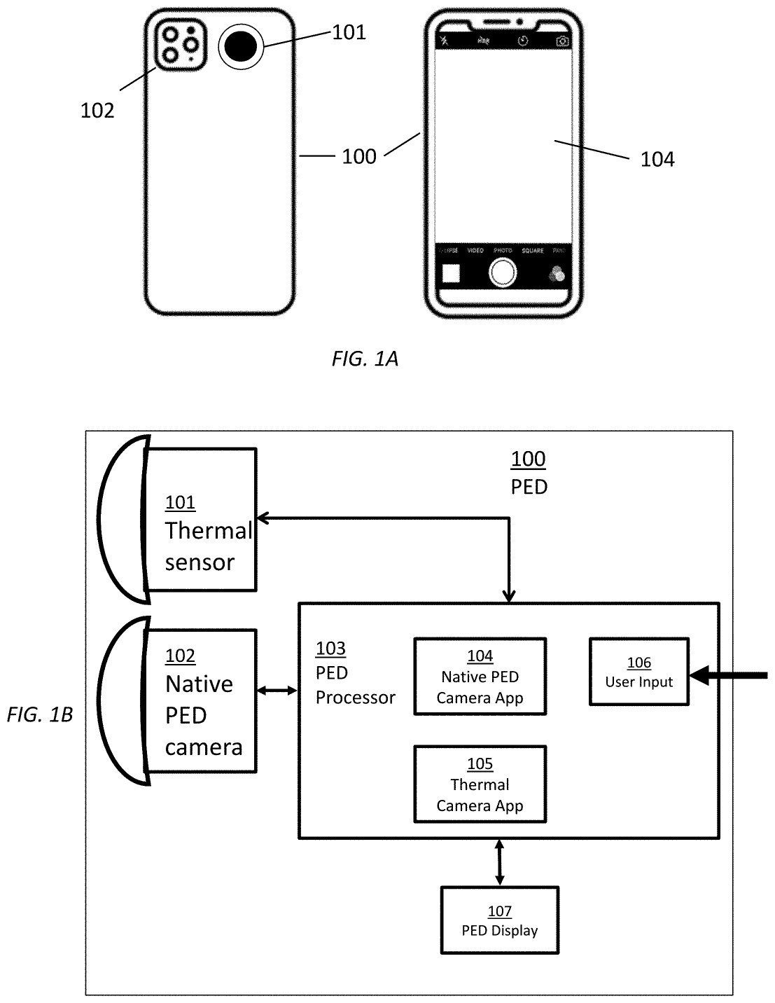

FIG. 1A shows back and front views of an example PED 100 with a native visible camera 102 and a fully integrated thermal sensor 101. Thermal sensor 101 may take the form of a spot temperature sensor having a small number of pixels (e.g., generally comprising 1 to less than 16 pixels). Thermal sensor 101 may also be a thermal camera, which may include a much larger number of pixels (e.g., many hundreds or thousands of pixels). Also shown in FIG. 1A is native visible camera app 104, of a common type found in many PEDs. The native visible camera app 104 generally includes a graphical user interface (GUI) including controls for capturing, viewing, and/or editing still pictures or video.

FIG. 1B is a block diagram illustrating a general system architecture of a PED 100 with native visible camera 102 and integrated thermal sensor 101. Both devices provide data to processor 103, which, usually under user input 106, provides access to, and control of, a variety of applications (apps). Particularly for the case where thermal sensor 101 is a camera, there will likely be a dedicated thermal app 105, which may provide expert level thermal analysis tools. Also present may be native a visible camera app 104, which is usually known and usable by non-experts. Apps may share display 107.

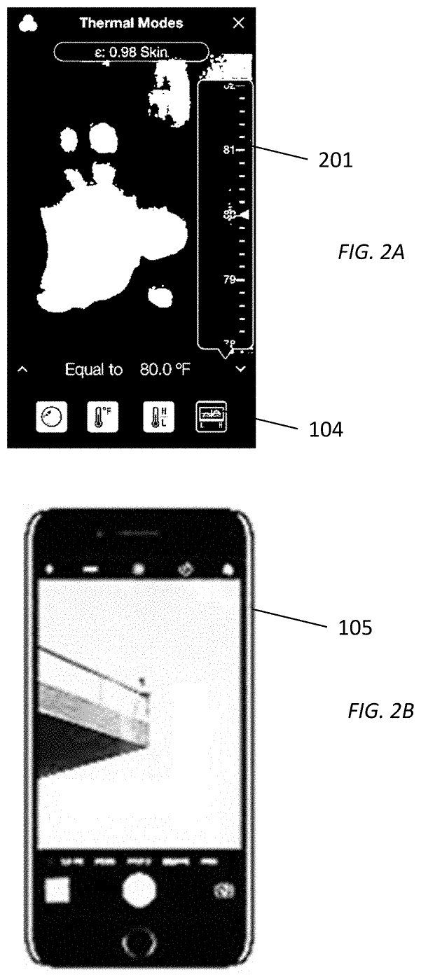

FIG. 2A shows one out of many screens of an example dedicated thermal app 104. Such an app provides a wealth of information and control of data display, all of which is useful to a thermal data expert. However, many PED consumers will not have the interest or expertise to use such an app effectively. FIG. 2B, by comparison, shows an example of a common native visible camera app, which almost all PED consumers can operate to at least an extent. For example, most PED consumers are able to operate intuitive features of a native visible camera app such as capturing images using a “shutter” button, view captured images in a gallery, select from among multiple modes and/or filters for image capture, and edit captured images using filters or other tools.

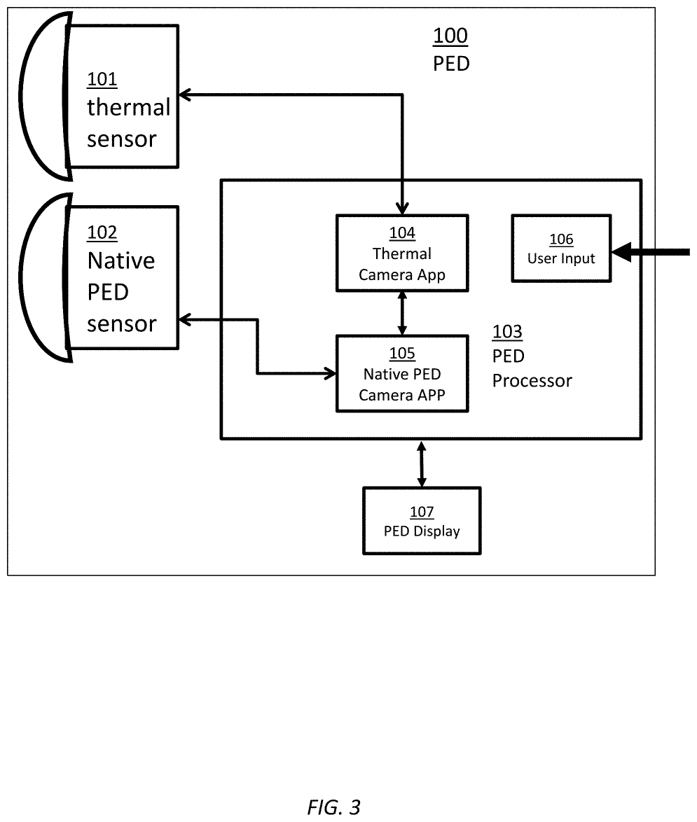

FIG. 3 is a block diagram illustrating a PED architecture that provides an alternate path to a PED user to access thermal data from a built in sensor. In this example, thermal data from sensor 101 undergoes whatever processing may be needed for compatibility by thermal app 104, and then is passed onto the native visible camera app 105. In the example shown, the processing is accomplished by thermal app 104, but the actual processing may be done according to the details of a given PED/thermal sensor design. Some integrated sensors may do all signal processing internally and pass processed data to the PED processor 103. Others may pass raw data to the processor. In many cases, signal processing is distributed between the sensor and the processor. Whatever the details of where the thermal data processing occurs, the result of an architecture akin to that of FIG. 3 is that thermal data in a usable form is presented to the native visible camera app 105 already familiar to most PED users.

Although details may be found elsewhere, and therefore not spelled out herein, some aspects of multi-sensor systems need to be discussed. In the case of a device containing separate visible and thermal sensors, if it is desired, and it usually is, to present fusion of the two data sets to a user, certain issues must be addressed. Generally, the two sensors have separate optical axes, different sized pixels, different numbers of pixels, different fields of view, and different valued optics. However, for the case of a PED as described, both sensors are aimed at the same scene, and therefore if meaningful fusion of the two data sets is desired, the portion of the scene viewed by a pixel in one sensor can preferably be correlated with the pixel viewing the same scene portion from the other sensor. Thus, the mapping between corresponding pixels in the two sensors should be known. For the case where the fields of view are not totally congruent, the mapping is applied to the pixels within overlapping fields of view. Otherwise, the full frames of both sensors are mapped to each other.

This mapping can be accomplished in a variety of ways described in detail elsewhere. However, some example techniques will be summarized below:
a) Mechanical mapping at manufacture—if the spacing, orientation, and component tolerances of the two sensors is either adequately controllable at manufacture or can be calibrated and fixed permanently, then the pixel mapping may be accomplished purely geometrically from the optical and dimensional parameters of the sensors. If one of the sensors, e.g. the thermal sensor, is not a full imaging sensor, this approach may be desirable.
b) Image Comparison Mapping—this may be done either at manufacturing calibration, during use, or some combination of the two. An example is edge alignment. Edges detected in images from the two sensors may be used to align and map pixels in the two sensors.
c) User input—Images may be displayed either overlaid or side by side, and a user may position and size the images with user interface controls, such as drag, pinch/zoom, and/or swipe gestures, to align observed features in both images. This technique may also be used with edge enhanced images.

Generally, some combination of the above techniques are applied to initially map pixels and to update the mapping over time. Again, depending on the nature of the sensors, differing degrees of alignment may be required, with full image fusion more demanding than pixel sensor mapping.

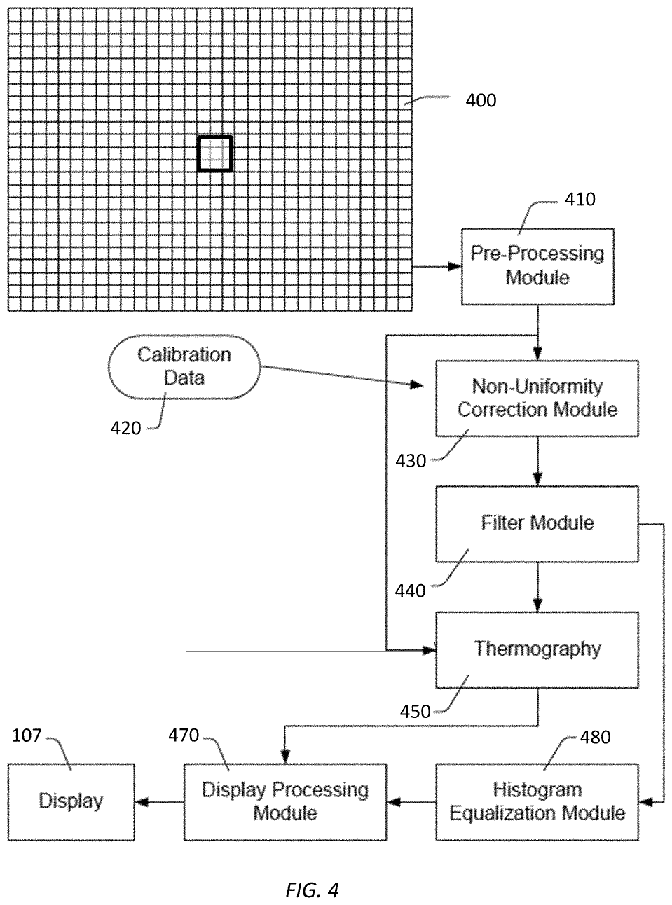

The raw data from thermal sensors is often not of use until a significant amount of signal processing is applied to it. Although thermal data signal processing is discussed in many forums, including a number of issued and pending patent applications owned by the owner of the current disclosure, a quick review is appropriate at this point. Referring to FIG. 4, data set 400 represents raw data from a thermal sensor, which may be in the form of full image frames or, for spot temperature measurement, just a few pixels, possibly just center pixels. The various modules in FIG. 4 form a signal processing chain, and are exemplary, and the elements shown are neither comprehensive nor are all required for all applications.

Some pre-processing is generally applied early in the chain at 410. An example is frame averaging. Thermal sensors tend to drift over time, primarily due to ambient temperature and warm-up, so generally drift corrections must be determined, updated and applied over time. For imaging sensors this is referred to as non-uniformity correction (NUC) at 430. Common techniques include exposing the sensor to a flat field (e.g., a shutter), and/or a variety of scene-based correction algorithms may be employed. Most often applied to imaging sensors, even single or small pixel count sensors are subject to the same drift effects. Data from factory or field calibration 420 is often part of NUC processes.

Thermal data tend to be noisy, and large pixel arrays may have a number of malfunctioning pixels. So a variety of temporal and spatial filters may be applied at 440.

The raw data from thermal sensors is related to scene temperatures, but actually deriving accurate temperature data from a thermal sensor is usually complicated and requires a variety of mathematical techniques often using calibration data 420 as part of the derivation. This process is known as thermography and may be an important piece of the processing chain at 450.

Raw Thermal data is usually digitized, and the digital words corresponding to pixel intensity values are usually at least the length of the digital conversion. This digital word size (e.g., 12, 14 or 16, bits) is typically larger than the display size of 8 bits. Thus, raw data may need to be compressed, and since most scenes contain a fixed number of temperatures, the compression process should assign the corresponding display levels in a way that doesn't waste contrast. This function is usually accomplished with a Histogram Equalization process at 480.

Finally, the display-sized data is processed for display, e.g colorized, at 470 and presented to display 107.

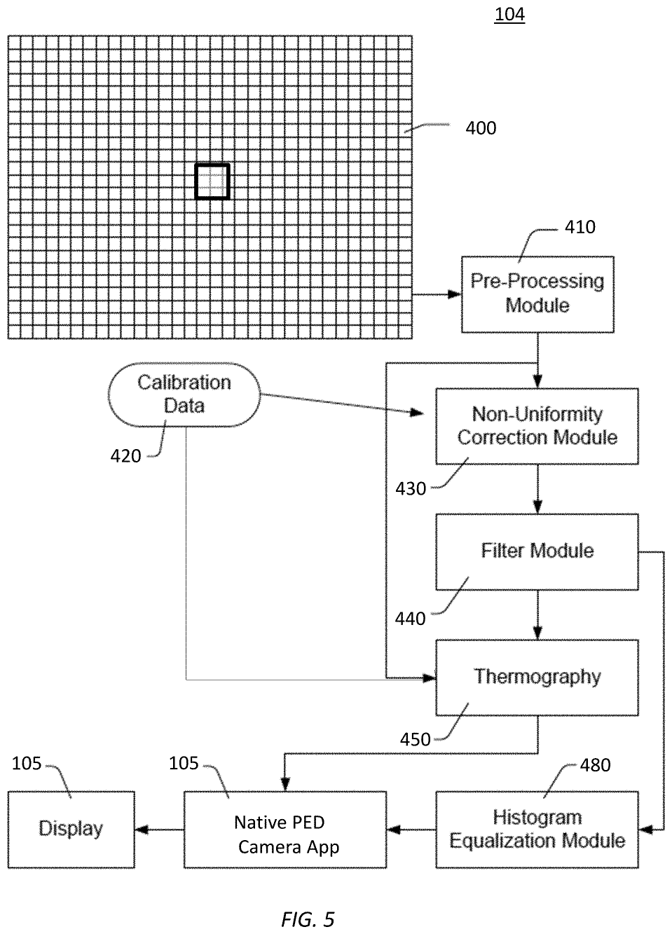

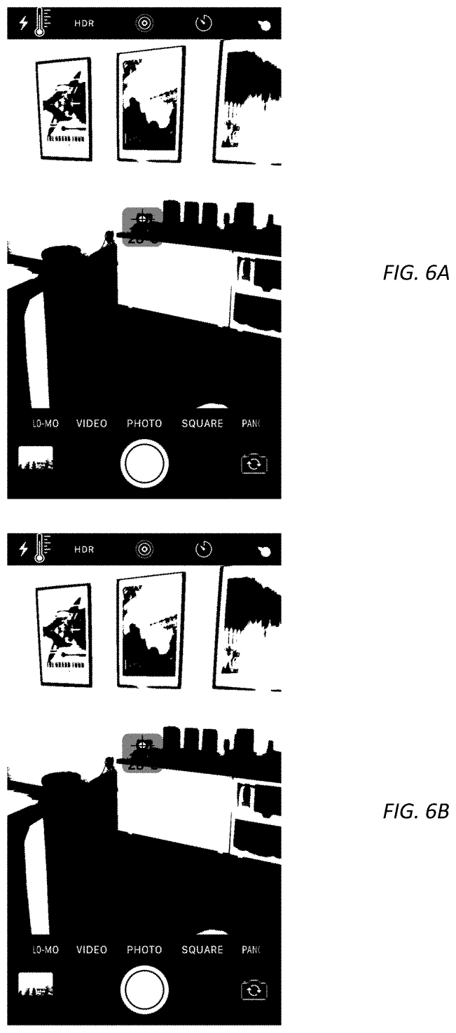

FIG. 5 shows an example of providing thermal data to a native camera app in a convenient form. To simplify, the data may be provided in display ready form, which would be after Histogram Equalization 480, as this point in the processing chain provides display ready data. Also, for true temperature display, thermography 450 temperature data for each pixel may also be provided. In some cases only a temperature for each pixel may be passed onto the native app, so only temperature (thermography) is displayed in the native app. This arrangement is only exemplary as other points in the chain may be desirable depending on the system configuration.

Once the native app is in possession of usable thermal data, related to and mapped to corresponding pixels in the visible image, it is possible to apply a variety of overlay, blend, pixel replacement, added temperature indicators, or other thermal enhancements to the visible image in the familiar native app.

FIG. 6A shows an example application of the current techniques. In FIG. 6A, a simple icon selected by a user causes the native app to acquire thermography data and display the temperature of the center of the visible image. Any user could easily use this function, and it would be universally useful. If this was the only thermal enhancement ported to the native app, the utility is apparent. This could be accomplished by only passing some number of the center pixel thermography information acquired from a built-in thermal camera, or it could also rely on a small pixel count sensor, mapped to the center of the visible camera.

FIG. 6B shows a slightly more complicated thermal enhancement. In this example, the user is allowed to select a number of locations in the visible image to display the corresponding temperature. This implementation would require the thermal sensor to be a camera, but the same idea applies of providing thermography data from the corresponding thermal pixels to the user selected visible pixels.

An alternative display arrangement would be to show an indication of touch temperature. Predetermined temperature ranges based on the thermography data derived from the thermal sensor could be established, and selected portions, such as the center pixels or selected pixels arrangement described above could also or instead of numerical temperature show colors coded to give a user an indication of touch temperature of the areas in the scene corresponding to selected pixels. For example, cold (e.g. less than 32 degrees) could be indicated by blue, hot (between 90 and 150 degrees) by yellow, and scalding (e.g. over 160) degrees by red. Colored crosshairs, colored numerals, colored dots or a variety of other indicators could be employed either with or in place of indicated numerical temperature. Such a capability would be very easy to use in the native camera app and of clear utility to most users.

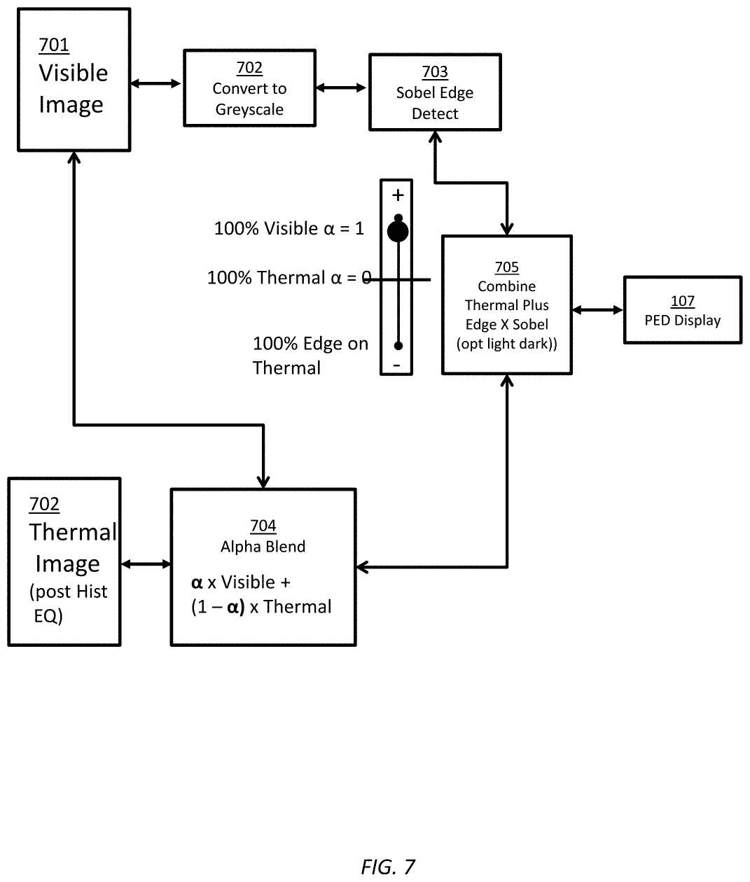

FIG. 7 shows an example technique to provide visible-thermal fusion to a native app user with one simple easy to understand control. Fusion takes many forms, but one of the most common is to enhance lower resolution thermal data with edges derived from a corresponding higher resolution visible image. Another common fusion technique is what is referred to as alpha blending, which includes overlaying the two images over each other with a variable (e.g., automatic or user-selectable) amount of transparency.

In FIG. 7, visible image 701 is converted to greyscale (if needed) 702 and an edge detection filter such as a Sobel edge detection filter 703 is applied, the result of which is a wireframe of the visible image, showing edges only. Visible image 701 along with thermal image 702 (or the corresponding mapped portions of both images) is also presented to alpha blend element 704. The two paths are combined at 705, and this element is controlled by one slider presented to the user in the native app. At one end of the slider, alpha is one and the image displayed 107 is purely the visible image, with no thermal information displayed or overlaid. In the middle, alpha is zero, and the image displayed is purely the thermal image, with no portion of the visible image overlaid or displayed. In between these positions, variable alpha blending is applied. If the slider is moved past the middle (e.g., beyond the point at which alpha is zero), the edge wireframe of the visible image may be progressively blended with the thermal image. Thus, the slider as a single, simple control in the native app can provide a non-expert user complete access to visible-thermal image fusion. Optionally, if the thermal image is mostly dark pixels, the edge image may be blended as light color, or as a dark color if the thermal image is lighter. Thus, in one example implementation, a first end or extreme position of the slider causes only the visible image to be displayed without thermal information. A second end or extreme position of the slider, opposite the first end, causes the thermal image to be displayed with the edge wireframe of the visible image overlaid thereon. An intermediate position (e.g., at the middle or a different intermediate location) causes only the thermal image to be displayed without visible image information. Positions of the slider between the first end and the intermediate position cause the visible image to be displayed, with the thermal image overlaid at varying degrees of transparency. Positions of the slider between the intermediate position and the second end cause the thermal image to be displayed, with the edge wireframe of the visible image overlaid at varying degrees of transparency.

The slider may also be used concurrently with the selected pixel temperature option. For instance when thermal mode is selected, both the slider and the center pixel temperature could be enabled, providing a very simple one control thermal data option easily accessible to PED users. Optionally, a user control to change the color tables of displayed data and/or edge color could be provided although this starts to move the simple thermal controls in the direction of full-featured thermal sensor apps.

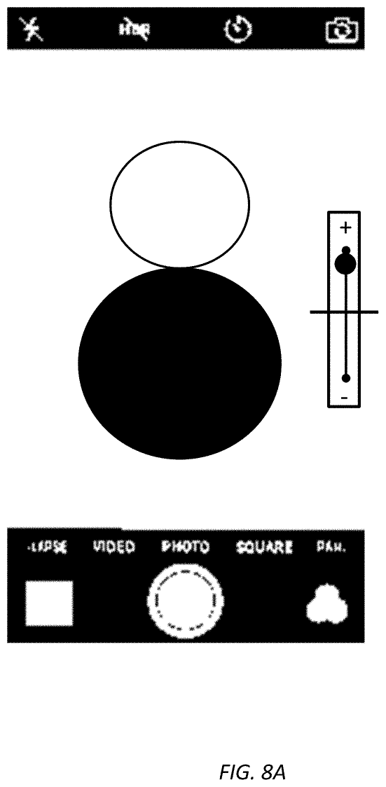

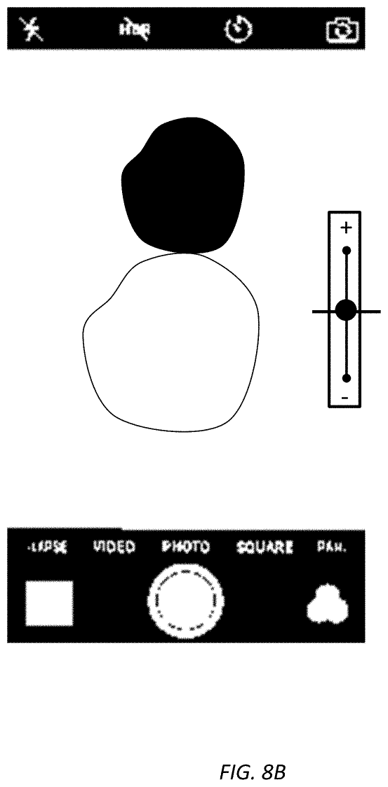

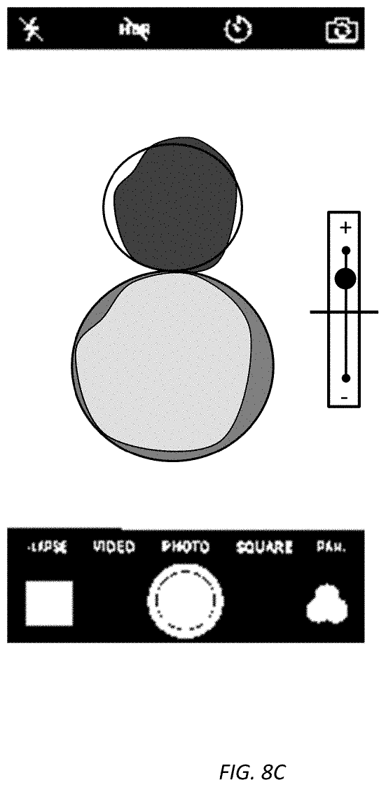

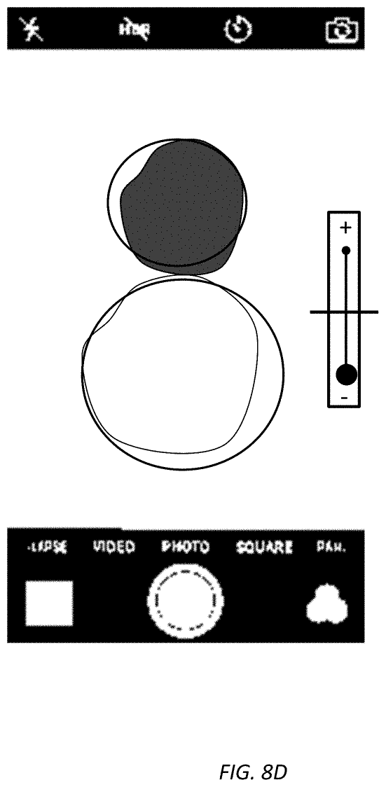

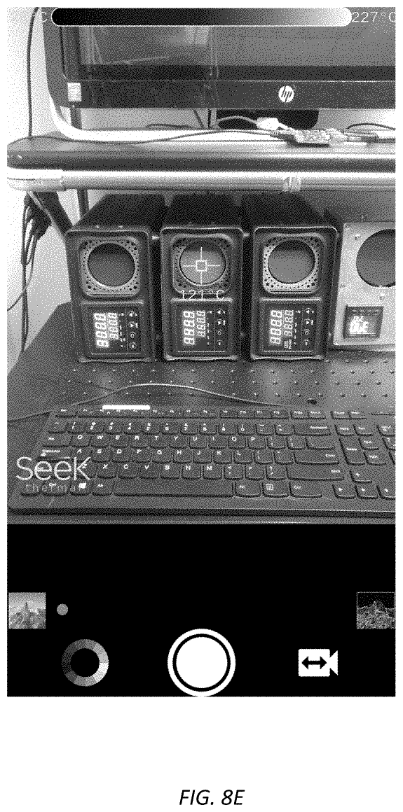

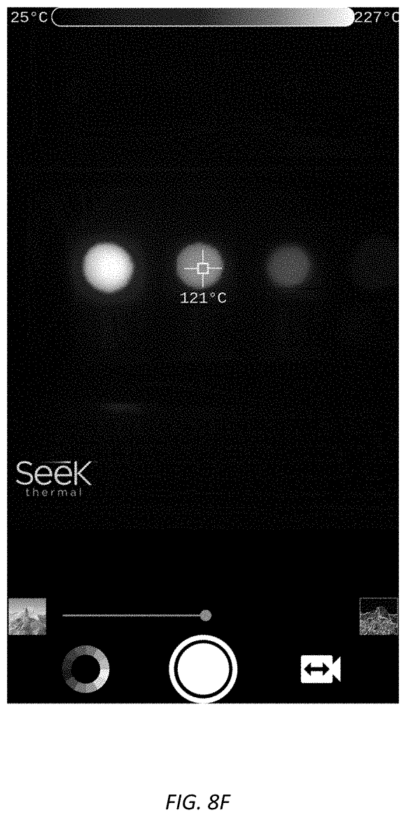

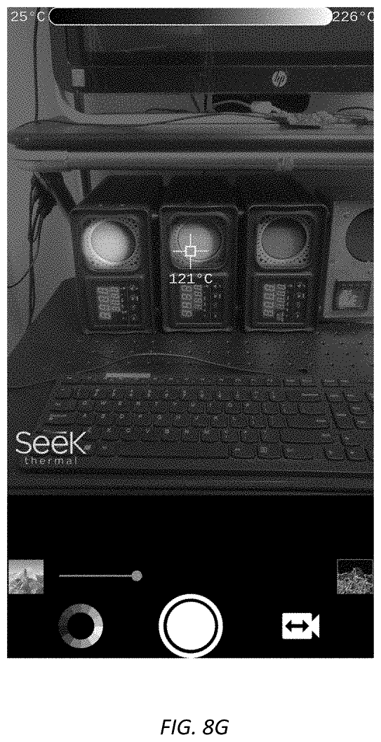

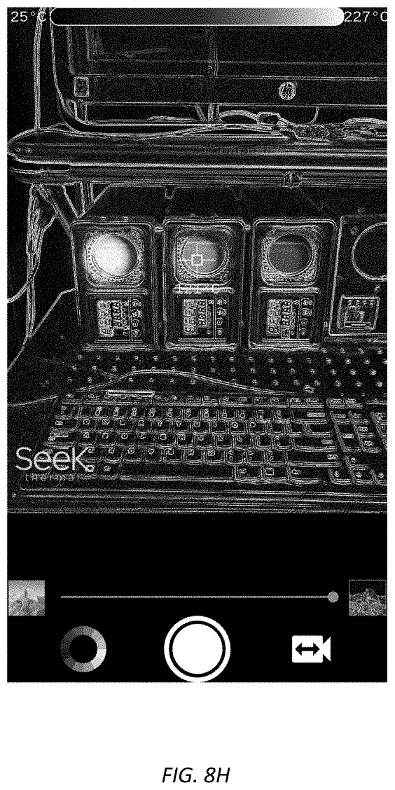

FIGS. 8A to 8D show an example slider bar display for a scene with two visible colors and two temperatures. To aid in showing the operation of the slider control, the following describes the set-up of the Figures. In the visible image of FIG. 8A, the image is represented by two circles, one colored black and the other white. The thermal image of FIG. 8B is a lower resolution rendition of the two circles, at two temperatures shown as two roughly circular blobs corresponding to the visible image circles, with the colors representing the two temperatures reversed from the visible image colors. Thus, the thermal image is shown as less sharp then the visible image, which is usually the case.

FIG. 8A shows the slider at one end and the display is purely the visible image. FIG. 8B with the slider in the middle displays pure thermal. FIG. 8C with the slider in between is a variable alpha blend of the two images, and FIG. 8D displays the thermal image with visible derived edges overlaid.

FIGS. 8E to 8H show a further example slider bar display for a scene with two visible colors and two temperatures. FIG. 8E is a visible image in which several pieces of electronic equipment are visible, indicated by the slider at the bottom of the display being at the far left end. FIG. 8F is a pure thermal image of the scene illustrated in FIG. 8E, in which most of the scene appears black due to being at approximately room temperature, while the circular displays of the electronic equipment appear in lighter colors due to being at substantially higher temperatures. FIG. 8G displays a variable alpha blend of the images of FIGS. 8E and 8F with the slider in an intermediate position, and FIG. 8H displays the thermal image of FIG. 8F with visible derived edges overlaid.

Other thermal enhancements may be made available in the native app. Picture in Picture mode is possible, i.e. a user-selected portion of pixels from the video image may be replaced with corresponding pixels from the thermal image. Or thresholding may be allowed where the thermal image data may replace the corresponding visible image data, or vice-versa, when the thermal image pixel values meet user selectable threshold criteria, including temperature above threshold, temperature below threshold, or temperature within threshold min/max limits. A color bar graphic may be overlaid on the PED display to show correlation between thermal data image color and temperature, as illustrated by element 201 in FIG. 2A.

However, as more features are implemented, the thermal enhancement to the native app becomes similar in complexity to a full featured dedicated thermal app which starts to defeat the purpose of making thermal enhancement easy and understandable to unsophisticated users. Just adding the center pixel temperature option and fusion control bar to the native visible app would provide a wealth of user-friendly access to thermal data in the native visible camera app, and may provide more than enough thermal information for the purposes of many PED consumers.

The native visible camera in most modern PEDs is usually a fairly high resolution imager, taking images that are many megapixels in size, and often over 10 megapixels. Thus, any saved native camera visible image may use on the order of 107 stored digital words. Thermal Imagers tend to be much lower in pixel count. For inclusion in PED design, current technology probably limits PED thermal imagers to Quarter Video Graphics Array (QVGA) or smaller, which is currently defined as 640×480 pixels, 307,200 pixels. This is much smaller than the visible camera image in terms of storage required. Thus it is practical, for a PED with an embedded thermal imager, to append corresponding mapped thermal data, either intensity, temperature or both, to each pixel in a visible image without paying a major memory penalty.

Accordingly, an additional native app capability is possible, namely either automatically or under user control, to append the corresponding thermal data to captured visible camera images. Such a capability means that thermal content of stored visible images will be available later, even if thermal display was not initially selected. In this mode, the native camera thermal capabilities such as spot temperature display, or the thermal slider control, could be accessible as image processing modes for previously acquired visible images. It would also be possible to pass the stored visible images (with appended thermal content) to a native thermal app for more detailed thermal analysis, again after the fact if interest in thermal content develops later or if it is just more convenient to snap a series of visible image and worry about thermal content later.

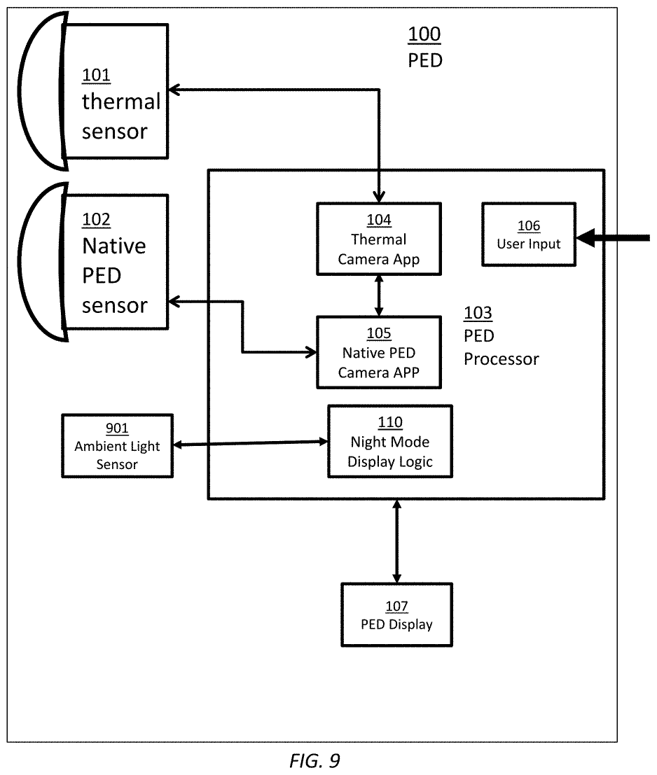

FIG. 9 shows a PED 100 with both visible and thermal sensors 101 and 102. The PED shown also contains an ambient light sensor 901, shown separately but it is understood that such a capability may also be part of or derived from the visible sensor, such as flash sensor for example. Such an ambient light sensor could trigger another user friendly thermal content mode, for example, a low light/night vision mode, implemented as night vision display logic 110 in the PED processor, which may or may not be part of the native camera app. For example, if the ambient light sensor detects a predetermined low light level, the night vision logic 110 may be directed to automatically display an image that is at a suitable point on the thermal slider control of FIG. 7. A variety of implementations of this concept are possible. In one example, the level of light and the slider display point could be automatically set by the app. In another example, the user could initiate this mode through the user interface. In some embodiments, the user may be able to set the thermal slider to a desired night vision configuration. In some embodiments, the thermal slider could be adaptively set as a function of the ambient light sensor signal, either automatically, with user input or some combination of both.

Of course, other “night vision” settings could be employed, triggered by ambient light conditions. However, the options available through the thermal slider functionality (e.g., combinations of blended thermal, visible, and edge data tailored for low light viewing, etc.) are particularly applicable.

Depending on the embodiment, certain acts, events, or functions of any of the processes described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and process steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a processor configured with specific instructions, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. For example, the LUT described herein may be implemented using a discrete memory chip, a portion of memory in a microprocessor, flash, EPROM, or other types of memory.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. A software module can comprise computer-executable instructions which cause a hardware processor to execute the computer-executable instructions.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, and Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to illustrative embodiments, it will be understood that various omissions, substitutions, and changes in the form and details of the devices or processes illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A personal electronic device (PED), comprising:
at least one visible camera;
at least one thermal sensor, wherein at least a portion of image pixel locations from the visible camera and the thermal sensor are mapped to each other; and
a processor and memory having instructions thereon that, when executed, cause the processor to run a native visible camera application for control and display of the visible camera;
wherein the native visible camera application is configured to:
extract information from selected thermal sensor pixels from thermal images; and
display the extracted information at least one of overlaid on, blended with, or in place of, corresponding pixels in a visible camera image captured by the visible camera.

2. The PED of claim 1, wherein the extracted information from selected thermal sensor pixels comprises a temperature corresponding to one or more center pixels in the visible camera image.

3. The PED of claim 1, wherein the extracted information from selected thermal sensor pixels comprises a temperature corresponding to one or more user selected pixels in the visible camera image.

4. The PED of claim 1, wherein the thermal sensor is a thermal camera, and wherein the extracted information from selected thermal sensor pixels includes thermal image frames acquired from the thermal camera.

5. The PED of claim 4, wherein the instructions further cause the processor to:
extract edge data from the visible camera image; and
map the extracted edge data from the visible camera image to all corresponding pixels in the thermal image.

6. The PED of claim 5, wherein extracting the edge data comprises applying a Sobel filter to a greyscale conversion of the visible camera image.

7. The PED of claim 5, wherein the extracted information, the corresponding pixels of the visible camera image, and extracted edge data are alpha blended or edge blended under user control by way of a single slider control.

8. The PED of claim 4, wherein the native visible camera application is further configured to overlay a color bar graphic on the PED display showing a correlation between thermal image color and temperature.

9. The PED of claim 4, wherein the extracted information and the corresponding pixels of the visible camera image are alpha blended under user control.

10. The PED of claim 4, wherein a pixel mapping between the thermal image frames and the visible camera image is at least partially accomplished with user input.

11. The PED of claim 4, wherein a user-selected portion of pixels from the visible camera image is replaced with corresponding pixels from the thermal image frames.

12. The PED of claim 4, wherein pixels of the thermal image frames replace the corresponding pixels of the visible camera image, or vice-versa, when the thermal image pixel values meet user-selectable threshold criteria, including temperature above threshold, temperature below threshold, or temperature within threshold minimum/maximum limits.

13. The PED of claim 4, wherein at least one of intensity or thermography data is derived and saved for at least a portion of pixels in each acquired thermal image frame.

14. The PED of claim 13, wherein the thermography data is displayed directly.

15. The PED of claim 13, wherein the native visible camera application is further configured to analyze saved visible camera image files with associated thermal data using thermal tools from at least one of the native camera or a dedicated thermal application.

16. The PED of claim 4, wherein pixel mapping is accomplished by deriving and aligning edge data from the two images by at least one of automated edge detection and alignment or with user input.

17. The PED of claim 4, wherein pixel mapping is accomplished at manufacture.

18. The PED of claim 4, wherein the field of view (FOV) of the visible camera image and the thermal image frames are not the same and only FOV overlapping portions of the images are mapped to each other.

19. The PED of claim 4, wherein the field of view of the visible camera image and the thermal image frames are matched and all corresponding pixels from both images are mapped to each other by at least one of automated alignment or with user input.

20. The PED of claim 1, wherein the information displayed is related to touch temperature including a blue region for cold and a red region for hot, wherein hot and cold are determined based on predetermined temperature ranges.

21. The PED of claim 20, wherein user controls for the slider display include choice of color tables for displayed images and choice of edge color.

22. The PED of claim 1, further comprising an ambient light sensor, wherein the application is further configured to display a combination of visible and thermal information to create a low-light viewing mode based at least in part on an ambient light level detected by the ambient light sensor.

23. A method of operation of a personal electronic device (PED), comprising at least one visible camera, at least one thermal sensor, and a native application for control and display of the visible camera, the method comprising:
mapping at least a portion of image pixel locations from the at least one visible camera and the at least one thermal sensor to each other;
extracting information, under user control of the native application, from selected pixels from thermal images captured by the at least one thermal sensor; and
displaying the extracted information at least one of overlaid on, blended with, or in place of, corresponding pixels in a visible camera image captured by the visible camera.

24. The method of claim 21, wherein the extracted information from selected thermal sensor pixels comprises a temperature corresponding to one or more center pixels or one or more user-selected pixels in the visible camera image.

25. The method of claim 21, wherein the thermal sensor is a thermal camera, and wherein the extracted information from selected thermal sensor pixels includes thermal image frames acquired from the thermal camera.
